(19) United States
(12) Patent Application Publication
(10) Pub. No.: US 2026/0206107 A1
(43) Pub. Date: Jul. 16, 2026

(54) A LIGHTING CONTROLLER FOR IMPLEMENTING DIMMING

(71) Applicant: KONINKLIJKE PHILIPS N.V., EINDHOVEN (NL)

(72) Inventor: MICHIEL HANS ZEINSTRA, BLAUWHUIS (NL)

(21) Appl. No.: 19/131,268

(22) PCT Filed: Nov. 16, 2023
(86) PCT No.: PCT/EP2023/081983

§ 371 Date: May 20, 2025

(30) Foreign Application Priority Data
Nov. 24, 2022 (EP) 22209379.1

(51) Int. Cl. H05B 45/10; H05B 45/325; H05B 45/59

(52) U.S. Cl. CPC H05B 45/10; H05B 45/325; H05B 45/59

(57) ABSTRACT

A lighting controller comprises a lighting driver and a control unit for controlling the lighting driver. The lighting driver has an analog dimming mode and a digital PWM dimming mode. A desired dimming level is converted to a combination of a first analog drive level with a first duty cycle and a second analog drive level, different to the first analog drive level, with a second duty cycle. A final drive signal is based on the combination. By using PWM control to alternate between two non-zero analog levels whenever possible, the perception of flicker is reduced and improved dimming ratios can be established.

### FIELD OF THE INVENTION

This invention relates to the control of lighting to perform a dimming function.

### BACKGROUND OF THE INVENTION

It is well known to provide lighting drivers, such as LED driver arrangements, with a dimming function.

Dimming control can be implemented by controlling the continuous analog current output, to provide analog dimming control. Another way to implement dimming control is to use pulse width modulation (PWM) dimming. The average current is controlled by chopping drive the current so that the light source experiences a discontinuous current. The pulse width of the current varies based on the dimming requirements.

Some LED driver ICs offer the combination of analog and digital dimming, for example the AL8861 from Diodes Inc. By means of an analog voltage or a digital PWM signal, the brightness of a LED can be controlled.

To achieve a wide range of controllability, there is a need to implement a deep dimming function. Deep dimming is a key parameter to meet the desired optical performance of a smart lighting system. For example, there are large differences between the color and color temperature coverage which can be achieved as between a 5% dimming capability and a 0.1% dimming capability.

A traditional driver system typically allows dimming of brightness down to a lower limit, such as a 5% brightness level. So called “deep dimming” below this lower limit is difficult to achieve with existing driver architectures, in particular based on switch mode power converter circuits.

Deep dimming can result in a stroboscopic effect. This is experienced when a low switching frequency is used. For example, above a 3 kHz switching frequency, no stroboscopic effect will be experienced. When deep dimming is required, for example to 1:1.000.000, the signal pulse duration, within the period of a 3 kHz signal, will be 333 ps. This requires a clock frequency of 3 GHz to generate the short duration pulse, and this is not possible in available microcontrollers and LED electronics.

Thus, deep dimming at a high PWM frequency (to avoid the stroboscopic effect) is difficult to achieve due to the short pulses needed. There is a need for an improved dimming solution.

WO 2013/039661 discloses a lighting circuit which uses a dimmer unit which can receive digital diming control signals and analogue dimming control signals. The dimming unit can also receive both analogue and digital dimming signals and then determine the requested brightness level.

### SUMMARY OF THE INVENTION

The invention is defined by the claims.

According to examples in accordance with an aspect of the invention, there is provided a lighting controller comprising:
a lighting driver; and
a control unit for controlling the lighting driver,
wherein the lighting driver has an analog dimming mode by which an analog drive level is adjustable and a digital dimming mode by which a duty cycle of a pulse width modulated drive level is adjustable,
and wherein the control unit is configured to control the lighting driver to generate a combination of a first analog drive level with a first duty cycle and a second analog drive level, different to the first analog drive level, with a second duty cycle, based on a desired dimming level.

This lighting controller combines pulse width modulation with analog level modulation. In this way, to achieve deep dimming, a low analog drive level may be used, and this will not require as low a duty cycle as a high analog drive level. Thus, longer on-pulses can be used which are easier to generate. The low dimming levels can be achieved without requiring such a small duty cycle.

The lighting controller also combines two pulse width modulation drive signals at different analog drive levels to arrive at a signal level corresponding to a desired dimming level. In this way, instead of the pulse width modulation alternating between a zero drive level and an active drive level, it alternates between two non-zero levels (at least for dimming levels above a minimum level). This reduces the perception of flicker. The invention thus combines analog and PWM dimming to enable improved dimming ratios to be established, as well as reducing modulation depth. The reduction in modulation depth further avoids a stroboscopic lighting effect or light flicker.

The analog dimming mode for example has a minimum analog level, a maximum analog level and a step size between permitted analog levels.

In some examples, the first analog drive level is one permitted analog level above the second analog drive level.

Thus, the final drive level is derived as a combination of two adjacent analog drive levels. For the deepest dimming, one of the two analog drive levels is zero (so that for the deepest dimming, the combined drive level will alternate between zero and the lowest permitted analog drive level),

The control unit is for example configured to transition from a first desired dimming level to a second desired dimming level, when said desired dimming levels are both above the minimum analog level, by adjusting the first and second duty cycles and/or the first and second analog drive levels progressively with no time of zero drive level. Thus, a PWM signal which has a zero component is avoided for all desired dimming levels other than the deepest dimming (when only a fraction of the lowest analog drive level is needed).

The first duty cycle is preferably the inverse of the second duty cycle. What is meant by this is that one analog drive level is active for a first part of the PWM cycle and the other analog drive level is active for the remaining second part of the PWM cycle. This gives no zero signal as mentioned above, when the two analog levels are non-zero.

When the desired dimming level is below the minimum analog level, the first analog drive level is the minimum analog level, the first duty cycle is less than 1 and the second analog drive level is zero. Thus, for deepest dimming, a conventional PWM signal is generated with the high signal level corresponding to the lowest permitted analog drive level.

The second analog drive level is preferably the maximum permitted analog drive level that, with 100% duty cycle, does not exceed the desired dimming level. In this way, the desired dimming level is obtained by averaging the permitted analog drive levels immediately above (the first level) and below (the second level) the desired dimming level.

The analog drive levels for example comprise analog drive voltage levels, and the lighting controller comprises a summing circuit for summing the first analog drive voltage level at the first duty cycle and the second analog drive voltage level at the second duty cycle. Thus, the dimming level is defined as an output voltage. This output voltage may then be converted to a drive current by a current driver.

The control unit is for example configured to adjust the pulse width control frequency in dependence on the desired dimming level. A lower frequency may be used, hence a longer time period, to enable deeper dimming. Because the modulation depth is reduced (only modulating between two adjacent permitted analog levels), the frequency is less critical, so that a lower frequency can be used before flicker becomes an issue.

The lighting driver is preferably a LED driver.

The invention also provides a lighting circuit comprising:
a light source; and
the lighting controller defined above.

The light source for example comprises a LED arrangement.

The invention also provides a method of controlling a lighting driver to implement a desired dimming level of a light source, wherein the lighting driver has an analog dimming mode by which an analog drive level is adjustable and a digital dimming mode by which a duty cycle of a pulse width modulated drive level is adjustable, the method comprising:
converting a desired dimming level to a combination of a first analog drive level with a first duty cycle and a second analog drive level with a second duty cycle; and
outputting a drive signal based on the combination.

The analog dimming mode for example has a minimum analog level, a maximum analog level and a step size between permitted analog levels. The first analog drive level is for example one permitted analog level above the second analog drive level. The first duty cycle is preferably the inverse of the second duty cycle.

The method may comprise transitioning from a first dimming level to a second dimming level, when said desired dimming levels are both above the minimum analog level, by adjusting the first and second duty cycles and/or the analog drive levels progressively with no time of zero drive level.

The invention also provides a computer program comprising computer program code which is adapted, when said program is run on the control unit of the lighting controller defined above to implement the method as also defined above.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows a lighting controller;

FIG. 2 shows the drive current to a light source during one period of the PWM drive signal;

FIG. 3 shows plots equivalent to FIG. 2 but showing drive voltages;

FIG. 4 shows an example of the summing circuit of FIG. 1; and

FIG. 5 is used to explain the operation of the circuit of FIG. 4.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a lighting controller which comprises a lighting driver and a control unit for controlling the lighting driver. The lighting driver has an analog dimming mode and a digital PWM dimming mode. A desired dimming level is converted to a combination of a first analog drive level with a first duty cycle and a second analog drive level, different to the first analog drive level, with a second duty cycle. A final drive signal is based on the combination. By using PWM control to alternate between two non-zero analog levels whenever possible, the perception of flicker is reduced and improved dimming ratios can be established.

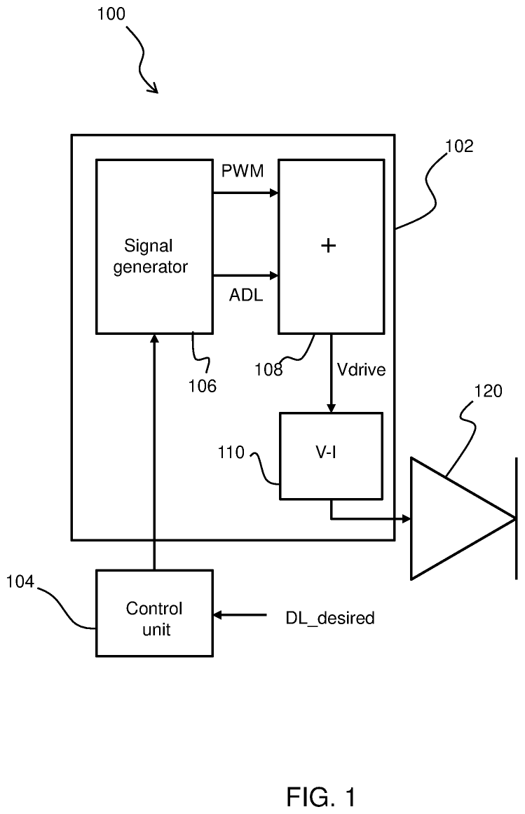

FIG. 1 shows a lighting controller 100 comprising a lighting driver 102 and a control unit 104 for controlling the lighting driver.

The lighting driver 102 has an analog dimming mode by which an analog drive level is adjustable and a digital dimming mode by which a duty cycle of a pulse width modulated drive level is adjustable. FIG. 1 shows a signal generator 106 of the lighting driver 102 which generates a PWM signal, which is a PWM waveform “PWM” and an analog drive level “ADL”.

The control unit 104 receives a desired dimming level “DL_desired” and in response it controls the lighting driver 102 to generate a combination of a first analog drive level with a first duty cycle and a second analog drive level, different to the first analog drive level, with a second duty cycle. The control unit for example communicates with the lighting driver over a communication bus such as I2C.

This lighting controller thus combines pulse width modulation with analog level modulation. In this way, to achieve deep dimming, a low analog drive level may be used, and this will not require such a low duty cycle. Thus, longer on-pulses can be used which are easier to generate.

By combining two pulse width modulation drive signals at different analog drive levels, the resulting pulse width modulation alternates between two close analog levels (e.g. two non-zero levels for dimming levels above a minimum level). This reduces the perception of flicker. Some driver circuits can be programmed to have independent PWM outputs, which can be used to generate the desired combined pulse width modulation signal.

In the example of FIG. 1, the combined PWM signal is generated in the voltage domain. A summing circuit 108 is used for this purpose, explained further below. There is then a voltage to current conversion, for example using a power supply circuit 110. This generates a drive current for a current-driven light source, such as an LED arrangement 120. The voltage to current conversion is part of the LED driver IC.

The operation of the lighting controller will now be explained.

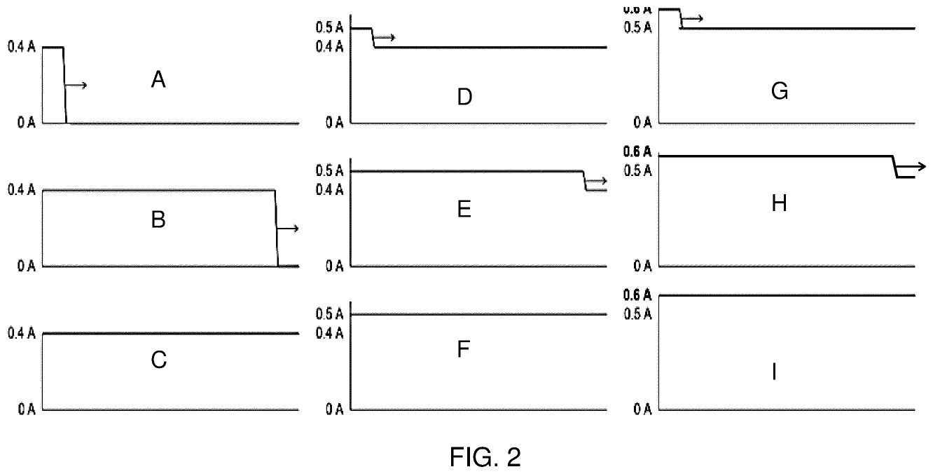

FIG. 2 shows the drive current to the light source during one period of the PWM drive signal. It shows the drive current at various dimming levels from a minimum brightness (maximum, deep, dimming) to a maximum brightness (no dimming).

The analog dimming mode for example has a minimum analog level, a maximum analog level and a step size between permitted analog levels. In the example shown, the minimum analog level results in a drive current of 0.4 A and the maximum analog level results in a drive current of 0.6 A with a 0.1 A step size. This is simply for illustration. The drive current may for example be adjustable between 0.4 A and 2.5 A by way of example, so with many more steps than shown in FIG. 2.

In plot A, near maximum dimming is shown. The analog drive level is the minimum 0.4 A and the duty cycle is at (or near) the lowest value. The average output current is below 0.4 A.

In plot B, the duty cycle is increased, so that the average output current is approaching 0.4 A. There are many incremental steps between A and B.

In plot C, the duty cycle has reached 100%, so that the average output current is 0.4 A.

For these plots, the first analog drive level is 0.4 A and the second analog drive level is 0 A.

At this point, the first analog drive level is switched to the next permitted drive level of 0.5 A and the second analog drive level becomes 0.4 A, so that an average current in the range 0.4 A to 0.5 A is possible. This assumes a notation that the higher level is the first level and the lower level is the second level. Of course the naming of the first and second levels is entirely arbitrary, so that equivalently it could be considered that the first analog drive level stays constant at 0.4 A and the second analog drive level jumps from 0 A to 0.5 A. For the purposes of this description the higher analog level is named as the first signal.

In plot D, a first part of the cycle (a first duty cycle) has the 0.5 A current (a first analog drive level) and a second part of the cycle (a second duty cycle) has the 0.4 A current (a second analog drive level). There is a low duty cycle so the average current is close to 0.4 A.

The first analog drive level is thus one permitted analog level above the second analog drive level. Even for deep dimming, when the second analog drive level is zero, the first may still be considered to be one analog level above the second. Thus, the final drive level is derived as a combination of two adjacent permitted analog drive levels.

In plot E, the duty cycle is increased for the higher first analog drive level and correspondingly reduced for the lower second analog drive level. There are many incremental steps between D and E.

In plot F, the duty cycle has reached 100% for the first analog drive level, so that the average is now 0.5 A.

At this point, the first analog drive level is switched to the next permitted drive level of 0.6 A and the second analog drive level becomes 0.5 A, so that an average current in the range 0.5 A to 0.6 A is possible.

In plot G, a first part of the cycle (a first duty cycle) has the 0.6 A current (a first analog drive level) and a second part of the cycle (a second duty cycle) has the 0.5 A current (a second analog drive level). There is a low duty cycle so the average current is close to 0.5 A.

In plot H, the duty cycle is increased for the higher first analog drive level and correspondingly reduced for the lower second analog drive level. There are many incremental steps between G and H.

In plot I, the duty cycle has reached 100% for the first analog drive level, so that the average is now 0.6 A corresponding to no dimming at all (if the maximum analog current is 0.6 A as in this simplified example).

The dimming ratio that can be achieved depends upon the lowest permitted analog drive level (i.e. the lowest possible analog current), the step size, the maximum analog drive level (i.e. the maximum analog current) and the duty cycle range of the PWM control.

When a change in desired dimming level is received, the lighting controller can switch directly to the new PWM settings. However, it is preferred that the light output is changed in a progressive manner, i.e. following the order of plots A to I for increased brightness (reduced dimming) or following the order of plots I to A for reduced brightness (increased dimming).

In this way, a transition from a first desired dimming level to a second desired dimming level involves adjusting the first and second duty cycles and/or the first and second analog drive levels progressively. This gives smooth switching of a lamp on and off. However, hard switching behavior may also be employed, with a more direct transition from one desired dimming level to another.

For desired dimming levels above the minimum non-zero analog drive level, there will be no time of zero drive level. Thus, a PWM signal which has a zero component is avoided for all desired dimming levels other than the deepest dimming (FIG. 2 plots A and B).

It can be seen that the first duty cycle is the inverse of the second duty cycle. Thus, one is high when the other is low, and together they occupy the full PWM period. Thus, one analog drive level is active for a first part of the PWM cycle and the other analog drive level is active for the remaining second part of the PWM cycle.

As mentioned above, the drive signal is for example generated in the voltage domain.

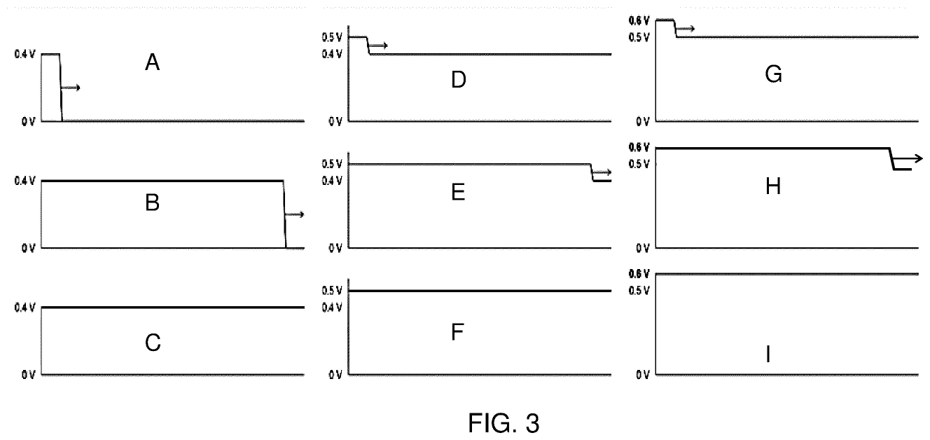

FIG. 3 shows plots equivalent to FIG. 2 but showing drive voltages. For simplicity, it is assumed that there is a one-to-one mapping between drive voltage and drive current, e.g. a drive voltage of 0.4V results in a drive current of 0.4 A.

These drive voltages are for example applied to the Vset pin of the LED driver IC AL8861.

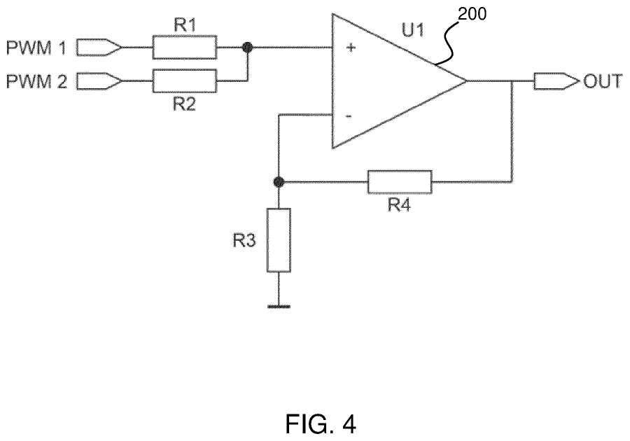

FIG. 4 shows an example of the summing circuit 108 of FIG. 1.

The summing circuit 108 comprises an opamp 200 in an adder circuit. The summing circuit receives two PWM signals PWM1 and PWM2, each of which is at its own analog drive voltage level and with its own duty cycle. As explained above, the two duty cycles are opposite to each other.

The two PWM signals are supplied to the non-inverting input through respective input resistors R1, R2, and the inverting input is connected to the junction between resistors R3 and R4 of a negative feedback path between the output and ground.

The output voltage can be calculated by the formula below when R1=R2:

$${V}_{out} = average ( PWM 1 , PWM 2 ) \cdot ( 1 + \frac{R 4}{R 3} )$$

This average is over the PWM period, and the resulting voltage may be considered to relate to a single time.

The resistors R3 and R4 may also be equal. It is noted that instead of an opamp circuit solution, the lighting driver may have the option to output a PWM with a flexible (programmable) voltage level.

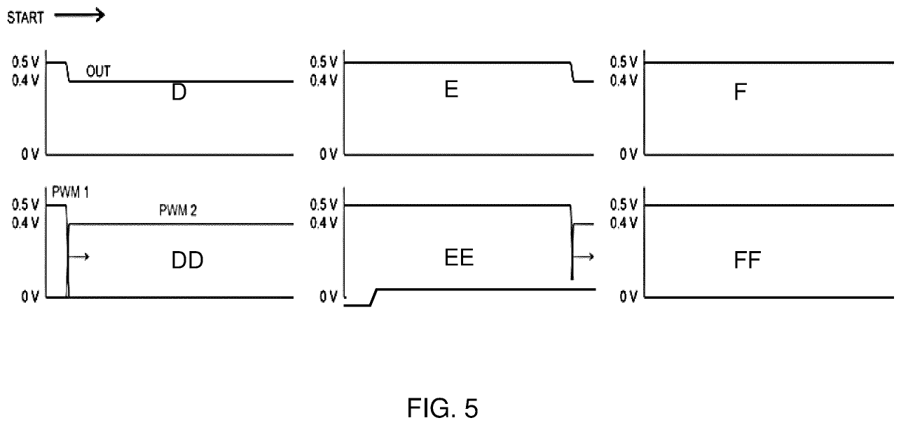

FIG. 5 is used to explain the operation of the circuit of FIG. 4.

Plots D, E and F correpond to the same plots in FIG. 3, to show an increase in output progressively from 0.4V to 0.5V. Plots DD, EE and FF show the associated PWM signals. PWM1 is the signal for the higher analog drive level. The progressive increase in the duty cycle of PWM1 can be seen as the average drive level increases from near 0.4V to 0.5V.

The active part of the PWM signal for the higher analog drive level may be at the beginning of the PWM cycle (as shown in FIG. 5, where the voltage has a step down during the PWM cycle) but it may be at the end of the PWM cycle instead (so the voltage has a step up during the PWM period).

Also, in the examples above, the duty cycle of a current amplitude level is increased to 100% before a new higher analog brightness level is introduced into the PWM period. Instead, the analog level of a PWM pulse of the currently chosen duty cycle may be followed by a remaining PWM period of the lowest amplitude. The PWM pulse may then be increased to a maximum level before the duty cycles are adapted. Thus, in the example above, the duty cycle is adjusted more quickly than the analog drive level when smoothly transitioning from one dimming level to another. In the alternative approach, the analog level is adjusted more quickly than the duty cycle when smoothly transitioning from one dimming level to another. This latter approach does not maintain adjacent analogue levels within each PWM cycle, but it still avoids flicker because there is still no time of zero light output (other than at the lowest dimming levels).

The control unit may also be able to adjust the pulse width control frequency in dependence on the desired dimming level. A lower frequency may be used, hence a longer time period, to enable deeper dimming. Because the modulation depth is reduced (only modulating between two adjacent permitted analog levels), the frequency is less critical, so that a lower frequency can be used before flicker becomes an issue. This thereby extends the dimming ratio further.

The invention may be applied to any lighting with a dimming function. One example is wake up lights which progressively increase in brightness to wake a person up, as a feature of an alarm clock.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

Functions implemented by a processor, e.g. of the control unit, may be implemented by a single processor or by multiple separate processing units which may together be considered to constitute a “processor”. Such processing units may in some cases be remote from each other and communicate with each other in a wired or wireless manner.

The mere fact that certain measures are recited in mutually different dependent claims does not indicate that a combination of these measures cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. A lighting controller comprising:
a lighting driver; and
a control unit for controlling the lighting driver,
wherein the lighting driver has an analog dimming mode by which an analog drive level is adjustable and a digital dimming mode by which a duty cycle of a pulse width modulated drive level is adjustable,
and wherein the control unit is configured to control the lighting driver to generate a combination of a first non-zero analog drive level with a first duty cycle and a second analog non-zero drive level, different to the first analog drive level, with a second duty cycle, based on a desired dimming level.

2. The lighting controller of claim 1, wherein the analog dimming mode has a minimum analog level, a maximum analog level and a step size between permitted analog levels.

3. The lighting controller of claim 2, wherein the control unit is configured to transition from a first desired dimming level to a second desired dimming level, when said desired dimming levels are both above the minimum analog level, by adjusting the first and second duty cycles and/or the first and second analog drive levels progressively with no time of zero drive level.

4. The lighting controller of claim 2, wherein the first duty cycle is the inverse of the second duty cycle.

5. The lighting controller of claim 2, wherein when said desired dimming level is below the minimum analog level, the first analog drive level is the minimum non-zero analog level, the first duty cycle is less than 1 and the second analog drive level is zero.

6. The lighting controller of claim 2, wherein the second analog drive level is the maximum permitted analog drive level that, with 100% duty cycle, does not exceed the desired dimming level and wherein the first analog drive level is one permitted analog level above the second analog drive level.

7. The lighting controller of claim 1, wherein the analog drive levels comprise analog drive voltage levels, and the lighting controller comprises a summing circuit for summing the first analog drive voltage level with the first duty cycle and the second analog drive voltage level with the second duty cycle.

8. The lighting controller of claim 1, wherein the control unit is configured to adjust the pulse width control frequency in dependence on the desired dimming level.

9. The lighting controller of claim 1, wherein the lighting driver is a LED driver.

10. A lighting circuit comprising:
a light source; and
the lighting controller of claim 1.

11. The lighting circuit of claim 9, wherein the light source comprises a LED arrangement.

12. A method of controlling a lighting driver to implement a desired dimming level of a light source, wherein the lighting driver has an analog dimming mode by which an analog drive level is adjustable and a digital dimming mode by which a duty cycle of a pulse width modulated drive level is adjustable, the method comprising:
converting a desired dimming level to a combination of a first non-zero analog drive level with a first duty cycle and a second non-zero analog drive level, different to the first analog drive level, with a second duty cycle; and
outputting a drive signal based on the combination.

13. The method of claim 12, wherein the analog dimming mode has a minimum analog level, a maximum analog level and a step size between permitted analog levels, wherein the first duty cycle is the inverse of the second duty cycle.

14. The method of claim 12, wherein the first analog drive level is one permitted analog level above the second analog drive level.

15. A non-transitory computer-readable storage medium having a stored computer program comprising instructions to control a lighting driver to implement a desired dimming level of a light source wherein the lighting driver has an analog dimming mode by which an analog drive level is adjustable and a digital dimming mode by which a duty cycle of a pulse width modulated drive level is adjustable which, when executed by a processor, cause the processor to:
convert a desired dimming level to a combination of a first non-zero analog drive level with a first duty cycle and a second non-zero analog drive level, different to the first analog drive level, with a second duty cycle; and
output a drive signal based on the combination.
